(19) United States
(12) Patent Application Publication
(10) Pub. No.: US 2019/0383521 A1
(43) Pub. Date: Dec. 19, 2019

(54) SEPARABLE BEARINGS FOR SUSPENDED SOLAR ENHANCED OIL RECOVERY CONCENTRATORS AND RECEIVERS, AND ASSOCIATED SYSTEMS AND METHODS

(71) Applicant: GlassPoint Solar, Inc., Fremont, CA (US)

(72) Inventors: Peter Emery von Behrens, Oakland, CA (US); Hayden Graham Burvill, San Carlos, CA (US)

(21) Appl. No.: 16/249,675

(22) Filed: Jan. 16, 2019

Related U.S. Application Data
(60) Provisional application No. 62/619,048, filed on Jan. 18, 2018.

(51) Int. Cl. F24S 30/425; F16C 17/10; F24S 23/70

(52) U.S. Cl. CPC F24S 30/425; F24S 2030/15; F24S 23/70; F16C 17/10

(57) ABSTRACT

Separable bearings for suspended solar enhanced oil recovery concentrators and receivers, and associated systems and methods. A representative bearing includes a receiver attachment member having a first bushing portion and a second bushing portion removably coupled to the first bushing portion, the first bushing portion having an outwardly-facing bearing surface, the receiver attachment member further including a plurality of engagement surfaces positioned to contact an outer surface of a receiver conduit. The bearing can further include a concentrator attachment member having a first element and a second element removably coupled to the first element, the first and second elements each having an inwardly-facing bearing surface positioned to rotatably engage with the outwardly-facing bearing surface of the first bushing portion, the concentrator attachment member further having first and second attachment elements positioned to couple to a solar concentrator.

### CROSS-REFERENCE TO RELATED APPLICATION

The present application claims priority to pending U.S. Provisional Application No. 62/619,048, filed on Jan. 18, 2018, and incorporated herein by reference in its entirety,

### TECHNICAL FIELD

The present technology is directed generally to separable bearings for suspended solar concentrators and receivers, and associated systems and methods. In some embodiments, the solar concentrators and receivers are used to heat water and/or another working fluid for thermal enhanced oil recovery.

### BACKGROUND

As fossil fuels become more scarce, the energy industry has developed more sophisticated techniques for extracting fuels that were previously too difficult or expensive to extract. One such technique is to inject steam into an oil-bearing formation to free up and reduce the viscosity of the oil. Several techniques for steam injection presently exist, and are often referred to collectively as “Thermal Enhanced Oil Recovery,” or “Thermal EOR.” Representative steam injection techniques include cyclic, steamflood, steam-assisted gravity drainage (SAGD), and other strategies using vertical and/or horizontal injection wells, or a combination of such wells, along with continuous, variable-rate, and/or intermittent steam injection in each well.

One representative system for generating steam for steam injection is a fuel-fired boiler, having a once-through configuration or a recirculating configuration. Other steam generating systems include heat recovery steam generators, operating in a continuous mode. Thermal EOR operations often produce steam 24 hours per day, over a period ranging from many days to many years, which consumes a significant amount of fuel. Accordingly, another representative steam generator is a solar steam generator, which can augment or replace fuel-fired boilers. Solar steam generators can reduce fuel use, reduce operations costs, reduce air emissions, and/or increase oil production in thermal recovery projects.

A representative solar energy system in accordance with the prior art includes multiple solar concentrators that concentrate incoming solar radiation onto corresponding receivers. Accordingly, the solar concentrators have highly reflective (e.g., mirrored) surfaces that redirect and focus incoming solar radiation onto the receivers. The receivers can take the form of elongated conduits or pipes. The receivers receive water that is heated to steam by the concentrated solar radiation provided by the concentrators. The concentrators and receivers can be housed in an enclosure that protects the concentrators from wind, dust, dirt, contaminants, and/or other potentially damaging or obscuring environmental elements that may be present in the local environment. The enclosure has supports from which the receivers are suspended, and the concentrators can in turn be suspended from the receivers. The concentrators can rotate relative to the receivers so as to track the motion of the sun, on a daily and/or seasonal basis. A bearing facilitates the rotation of the concentrator while the receiver remains in a generally fixed position.

While the foregoing arrangement provides suitable thermal energy to end users, the inventors have identified several techniques that significantly improve the performance of the system, and particularly the bearings, as discussed in further detail below.

### BRIEF DESCRIPTION OF THE DRAWINGS

FIG. 1 is a partially schematic, isometric view of a system that includes an enclosure, with concentrators and receivers supported within the enclosure in accordance with some embodiments of the present technology.

FIG. 2 is a partially schematic, end view of a representative enclosure having a receiver and concentrator supported by a bearing configured in accordance with embodiments of the present technology.

FIG. 3 is a partially schematic, axial cross-sectional view of a receiver having a bearing configured and positioned in accordance with embodiments of the present technology.

FIG. 4 is a partially schematic, isometric illustration of a bearing configured in accordance with embodiments of the present technology.

FIG. 5 is a partially schematic, exploded end view of a bearing configured in accordance with embodiments of the present technology.

FIG. 6 is a partially schematic, exploded isometric view of a portion of the bearing shown in FIG. 5.

FIG. 7 is a partially schematic, cross-sectional view of a portion of a bearing configured in accordance with embodiments of the present technology.

### DETAILED DESCRIPTION

### 1.0 Overview

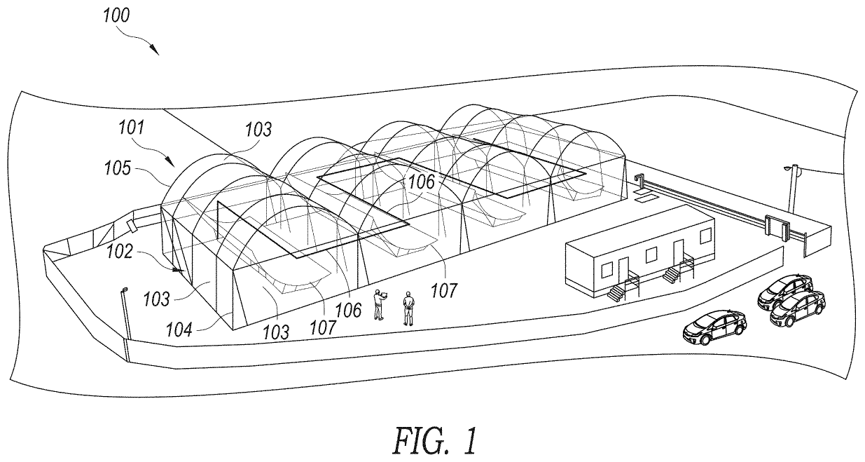

The present technology is directed generally to bearings and other equipment used to support solar concentrators relative to solar receivers, and associated systems and methods, including techniques for supporting the solar concentrators. The solar concentrators can be used for generating steam for a variety of processes including power generation, heating, and/or solar enhanced oil recovery. Specific details of some embodiments of the disclosed technology are described below with reference to a system configured for oil well steam injection to provide a thorough understanding of these embodiments, but in some other embodiments, representative systems can be used in other contexts, e.g., to provide steam for power generation and/or process heat. Several details describing structures or processes that are well-known and often associated with steam generation systems, but that may unnecessarily obscure some significant aspects of the present technology, are not set forth in the following description for purposes of clarity. Moreover, although the following disclosure sets forth several embodiments of different aspects of the presently disclosed technology, several other embodiments of the technology can have configurations and/or components different than those described in this section. Accordingly, the presently disclosed technology may include embodiments with additional elements and/or without several of the elements described below with reference to FIGS. 1-7.

Aspects of the present technology improve upon the prior art in one or more of several areas. These areas include: reducing the extent to which the bearing shades or blocks sunlight from reaching the receiver, reducing potential damage to the receiver as the bearing is installed, reducing installation and/or replacement time and cost, and/or reducing the overall weight and cost of the bearing and associated components.

### 2.0 Representative Bearings and Associated Systems and Methods

FIG. 1 is a partially schematic isometric illustration of a system 100, including an enclosure 101 housing solar concentrators 107 and receivers (e.g., elongated tubes, pipes, and/or conduits) 106. In some embodiments, the enclosure 101 includes a support structure 102 that in turn includes curved support members 105 supported by uprights 104, which together support one or more transparent thin film sections 103 in a tensioned arrangement to protect the interior of the enclosure 101. Inside the enclosure 101, the multiple concentrators 107 direct incoming sunlight to the corresponding receivers 106 to heat water or another working fluid (e.g., a molten salt or other high temperature working fluid) passing through the receivers 106. When the working fluid includes water, at least some of the water can be (but need not necessarily be) converted to steam. The heated working fluid can be used, directly or indirectly, for power generation, solar enhanced oil recovery (EOR) operations, and/or other industrial processes.

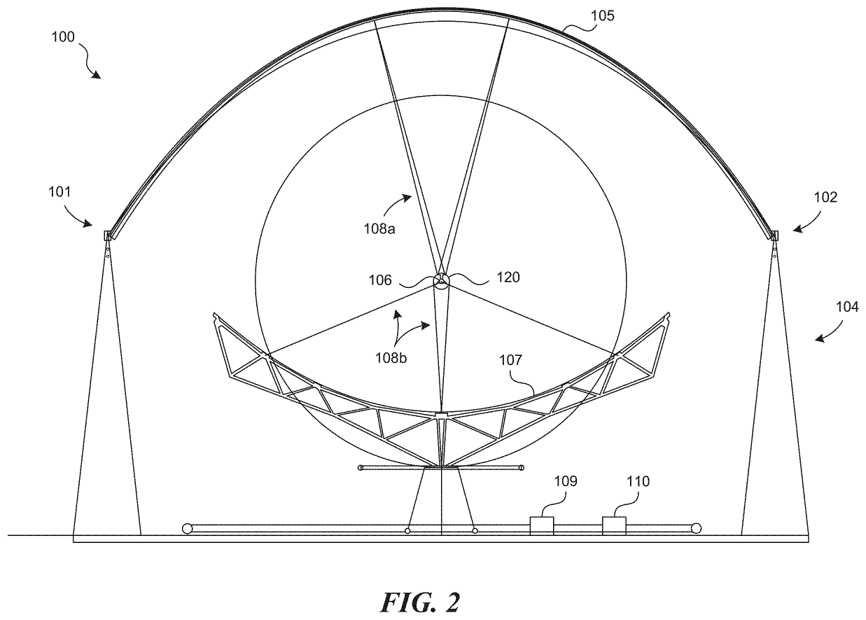

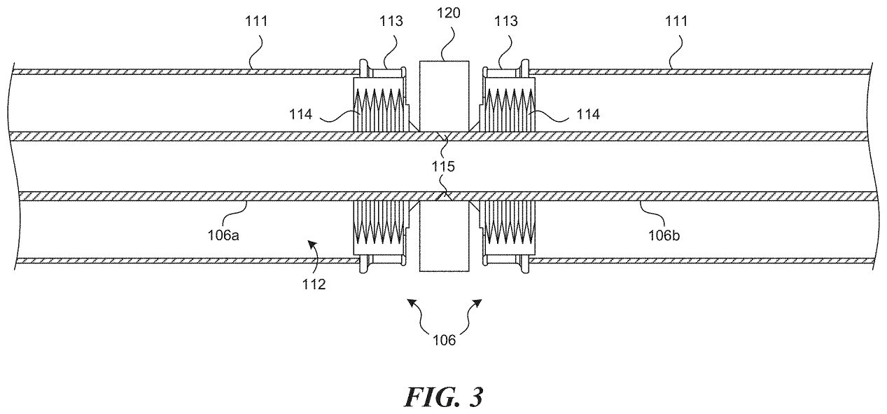

FIG. 2 is a partially schematic, end view illustration of a representative system 100 generally similar to that shown in FIG. 1. Accordingly, the system 100 can include uprights 104 and curved support members 105 that support the receiver 106 and the concentrator 107 in a suspended arrangement within the enclosure 101. A bearing 120 is operably positioned between the receiver 106 and the concentrator 107 to allow the concentrator 107 to smoothly rotate relative to the receiver 106. Accordingly, the bearing 120 can be operably connected between receiver tension members 108a that suspend the receiver 106 relative to the support structure 102, and concentrator tension members 108b that suspend the concentrator 107 relative to the receiver 106. The motion of the concentrator 107 relative to the receiver 106 is controlled by an actuator 109 under the direction of a controller 110, e.g., to track the daily and/or seasonal motion of the sun. Further details of representative bearings 120 that facilitate this motion are described below with reference to FIGS. 3-7.

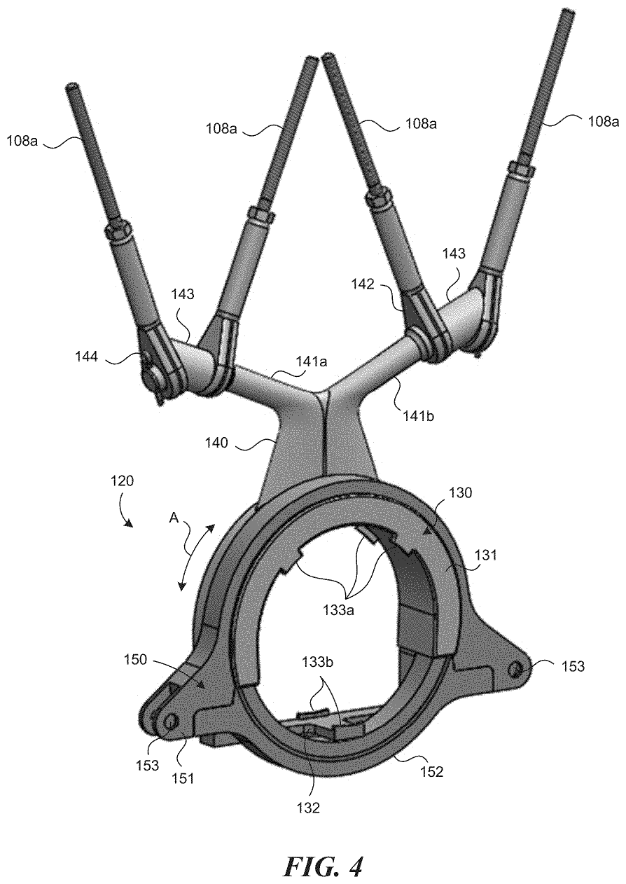

FIG. 3 is a partially schematic, partial cross-sectional illustration of a representative receiver 106, taken along a lengthwise axis of the receiver 106. The receiver 106 can include multiple receiver sections, illustrated as a first section 106a and a second section 106b, joined at a weld or other suitable joint 115. Each receiver section 106a, 106b can include an barrier 111 (e.g., formed from glass or another high temperature, transparent material) that restricts heat transfer away from the receiver 106. An annular region 112 between the receiver sections 106a, 106b and the corresponding barriers 111 can be evacuated, with the vacuum maintained via a glass-to-metal seal 113, with a bellows 114 provided to account for different rates of thermal expansion. The bearing 120 can be positioned at the joint between adjacent receiver sections 106a, 106b, e.g., over the weld 115, or at other suitable locations. By spanning the weld 115 (or other surface features), the bearing 120 can be positioned over a region of the receiver 106 that may have less than optimal heat absorption/conduction characteristics. Accordingly, the effect of placing the bearing on the conduit 116 (which may slightly degrade the heat absorption properties of the conduit) can be mitigated. Further details of the bearing 120 are described below with reference to FIGS. 4-7.

FIG. 4 is a partially schematic, isometric illustration of a representative bearing 120. The bearing 120 can include a receiver attachment member 140, a concentrator attachment member 150, and a bushing 130 that facilitates relative rotation of the concentrator attachment member 150 relative to the receiver attachment member 140, as indicated by arrow A.

The receiver attachment member 140 can include multiple, upwardly extending arms 141, shown in FIG. 4 as a first arm 141a and a second arm 141b. Each arm 141 can be attached to one or more receiver tension members 108a that extend upwardly to the curved support members 105 (shown in FIG. 2). Individual receiver tension members 108a can be pivotably or rotatably coupled to the corresponding arms 141a, 141b to allow the receiver tension members 108a to rotate as the corresponding receiver (not shown in FIG. 4) expands and contracts in a longitudinal direction. Stop elements 142, spacers 143, and retainers 144 (e.g., cotter pins) can maintain the spacing and position of the individual receiver tension member 108a.

The receiver attachment member 140 includes (e.g., can be integrally cast or otherwise formed with, or attached to) the bushing 130, which facilitates the rotation of the concentrator attachment member 150. The bushing 130 and the concentrator attachment member 150 can include multiple, separable and re-attachable elements that can allow these structures to be easily attached to and removed from the corresponding receiver. For example, the bushing 130 can include a first bushing portion 131 removably attached to a corresponding second bushing portion 132. The concentrator attachment member 150 can include a first attachment element 151 removably connected to a second attachment element 152. Together, the first and second attachment elements 151, 152 rotate relative to the receiver attachment member 140.

The receiver attachment member 140 can be fixedly clamped against the outer surface of the receiver. The multiple receiver engagement surfaces 133, shown as first receiver engagement surfaces 133a (carried by the first bushing portion 131) and second receiver engagement surfaces 133b (carried by the second bushing portion 132) are positioned to bear against the outer surface of the receiver when the first and second bushing members 131, 132 are attached. The concentrator attachment member 150 can include one or more attachment elements 153 (e.g., apertures) that facilitate connections with the corresponding concentrator 107 (FIG. 2) via concentrator tension members 108b (FIG. 2).

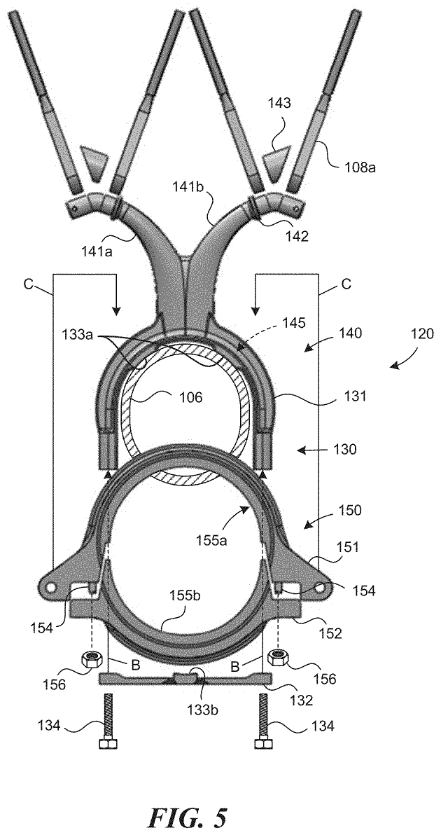

FIG. 5 is a partially schematic, exploded end view of an embodiment of the bearing 120. The arms 141a, 141b have a different shape than the corresponding arms shown in FIG. 4, but in other respects, the operation of the bearing 120 shown in FIG. 5 is generally similar to that of the bearing 120 shown in FIG. 4. To install the bearing 120, the first bushing portion 131 of the receiver attachment member 140 is placed around the receiver 106, with the first receiver engagement surfaces 133a in contact with the outwardly facing surface of the receiver 106. The second bearing portion 132 is then moved into position to abut the first bearing portion 131 and encircle the receiver 106, as indicated by arrows B. The second bushing portion 132 is then releasably attached to the first bushing portion 131, e.g., via threaded fasteners 134 or other suitable devices.

The first bushing portion 131 can include an outwardly facing bearing surface 145. The first attachment element 151 is placed downwardly onto the first bushing portion 131 (as indicated by arrows C) so that a first inwardly facing bearing surface 155a of the first attachment element 151 is in contact with the outwardly facing bearing surface 145 of the first bushing portion 131. The second attachment element 152 of the concentrator attachment member 151 is then releasably attached to the first attachment element 151 e.g., via one or more studs 154 and nuts 156. Accordingly, the concentrator attachment member 150 does not bear against the receiver 106 but is instead supported by the outwardly facing bearing surface 145 for a rotation relative to the receiver 106. In the orientation shown in FIG. 5, the first inwardly facing surface 155a contacts the outwardly facing bearing surface 145. When the concentrator 107 (FIG. 2) rotates sufficiently relative to the receiver 106, a second inwardly facing bearing surface 155b of the second attachment member 152 contacts the outwardly facing bearing surface 145. Accordingly, the first and second inwardly facing surfaces 155a, 155b can support the concentrator 107 relative to the receiver 106 through all expected concentrator rotation angles.

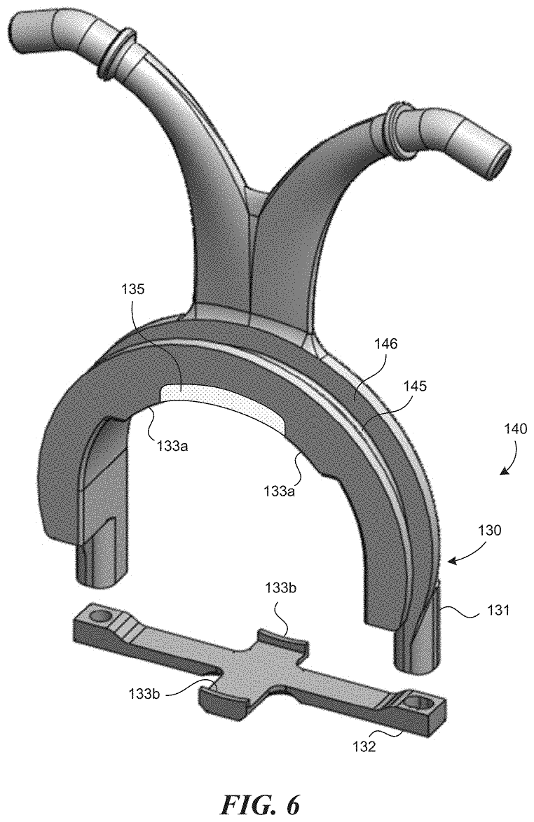

FIG. 6 is a partially schematic, isometric illustration of the receiver attachment member 140, including the outwardly facing bearing surface 145. The outwardly facing bearing surface 145 can be positioned in a channel 146, which receives the concentrator attachment member 150 described above with reference to FIG. 5. The channel 146 can accordingly restrict the axial motion of the concentrator attachment member 150 relative to the receiver attachment member 140, while facilitating relative rotation between these two elements. FIG. 6 also illustrates two of the first receiver engagement surfaces 133a carried by the first bushing portion 131, and the second receiver engagement surfaces 133b carried by the second bushing portion 132. As shown in FIG. 6, the receiver engagement surfaces 133a, 133b are positioned to contact the receiver 106 (FIG. 5) at three circumferentially spaced-apart positions, and at two axially spaced-apart positions. This arrangement can firmly clamp the receiver 106 in position.

The relatively short circumferential dimensions of the receiver engagement surfaces 133 can provide one or more of several heat-transfer-related advantages. For example, the short circumferential dimensions reduce the surface area of the receiver attachment member 140 that is in direct contact with the receiver. This in turn reduces the heat transfer rate from the receiver to the receiver attachment member 140 and the other elements of the bearing 120. The lower heat transfer rate can reduce the thermal design requirements for the bearing 120 and/or increase the longevity of the bearing 120, which can be particularly important when the receiver carries a molten salt or other high temperature working fluid. The gaps between the receiver engagement surfaces 133 can be occupied by air or another suitable insulating material 135 (e.g., another gas, or a solid, such as a ceramic) to further reduce the conductive and/or radiative heat transfer rate from the working fluid and the receiver to the bearing 120. For purposes of illustration, the insulating material 135 is shown between two first receiver engagement surfaces 133a, but can be located adjacent any of the receiver engagement surfaces 133 depending on the desired level of insulation.

In particular embodiments, the receiver attachment member 140 or portions of the receiver attachment member 140 can be formed from at least somewhat flexible materials (e.g., Inconel, stainless steel, and/or others). The two-part construction of the bushing 130 can accommodate a significant degree of variation in the outer diameter of the corresponding receiver 106, which can be further accommodated by the flexible materials described above. Either/both can in turn can allow the manufacturer/integrator to tolerate greater variations in the outer diameter, which in turn can allow the manufacturer to use cheaper manufacturing methods. For example, the receiver 106 can be formed in a (less precise) hot rolling process rather than a (more precise) cold rolling process.

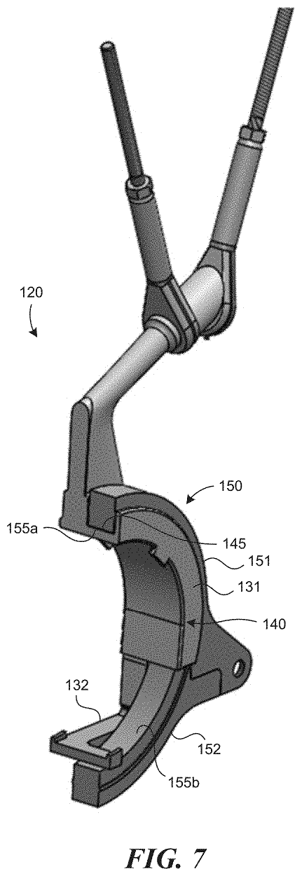

FIG. 7 is a partially schematic, cross-sectional illustration of the bearing 120 configured in accordance with embodiments of the present technology. As shown in FIG. 7, the first inwardly facing bearing surface 155a of the concentrator attachment member 150 is engaged with the outwardly facing bearing surface 145 of the receiver attachment member 140. In a representative embodiment, the second bushing portion 132 can be formed from Inconel, stainless steel, and/or another suitable material so as to resiliently clamp the receiver 106 (FIG. 5) between the second bushing portion 132 and the first bushing portion 131

As discussed above, one feature of at least some of the foregoing embodiments is that one or more portions of the receiver attachment member can be formed from a resilient material that accommodates variations in the outer diameter of the receiver to which the receiver attachment member is connected. This in turn can relax the tolerances to which the receiver must be manufactured, which in turn can reduce receiver cost. Because a typical solar collection installation can include many hundreds of meters of receiver conduit, the associated cost savings can be significant.

Embodiments of the foregoing system can include further advantages, in addition to or in lieu of the advantages described above. For example, the separable components of the receiver attachment member and the concentrator attachment member can allow the operator or installer to position the bearing directly at a particular axial location along the receiver without sliding the bearing along the length of the receiver to get there. This can reduce the time and cost for installing the bearings, and can reduce the likelihood for damaging the receiver and/or its associated barrier. Furthermore, in the unlikely event that a bearing fails or for any other reason requires replacement, the bearing can be easily removed and replaced, again without the need for sliding the bearing along the length of the receiver. Still further, the receiver will typically not require any treatment or post-manufacturing processes (e.g., machining a uniform circular groove in it) to receive the bearing. Yet further, the limited contact area between the receiver attachment member and the receiver, and the presence of air gaps between neighboring receiver engagement surfaces, reduces the heat load on the bearing overall, and therefore can increase the longevity of the bearing, and/or increase the choice of suitable materials for manufacturing the bearing.

From the foregoing, it will be appreciated that representative embodiments of the present technology have been described herein for purposes of illustration, but that the technology can include suitable modifications, without deviating from the technology. For example, at least some of the specific shapes of the components shown in the foregoing figures may be altered without significantly affecting the overall function performed by these elements. Certain aspects of the technology described in the context of some embodiments may be combined or eliminated in other embodiments. For example, in some embodiments, the bearing can include fewer than or more than the number of receiver engagement surfaces illustrated in the foregoing Figures. Further, while advantages associated with certain embodiments of the present technology have been described in the context of such embodiments, other embodiments may also exhibit such advantages, and not all embodiments need necessarily exhibit such advantages to fall within the scope of present technology. Accordingly, the present disclosure and associated technology can encompass other embodiments not expressly described or shown herein.

As used herein, the phrase “and/or” as in “A and/or B” refers to alone, B alone and both A and B. To the extent any materials incorporated herein by reference conflict with the present disclosure, the present disclosure controls.

I/we claim;:

1. A solar concentrator system, comprising:
an elongated, tubular receiver having an outer surface;
an elongated, trough-shaped solar concentrator; and
a bearing coupled to the receiver and the concentrator to support rotation of the concentrator relative to the receiver, the bearing comprising:
a receiver attachment member having a first bushing portion and a second bushing portion removably coupled to the first bushing portion, the first bushing portion having an outwardly-facing bearing surface, the receiver attachment member further including a plurality of receiver engagement surfaces in contact with the receiver outer surface; and
a concentrator attachment member having a first element and a second element removably coupled to the first element, the first and second elements each having an inwardly-facing bearing surface positioned to rotatably engage with the outwardly-facing bearing surface of the first bushing portion; and
a tension member connected between the concentrator attachment member and the solar concentrator.

2. The system of claim 1 wherein the plurality of receiver engagement surfaces includes at least one first receiver engagement surface carried by the first bushing portion and at least one second receiver engagement surface carried by the second bushing portion.

3. The system of claim 1, further comprising a thermal insulating material positioned adjacent to at least one of the receiver engagement surfaces.

4. The system of claim 1 wherein the tension member is a first tension member, and wherein the system further comprises a second tension member connected between the receiver attachment portion and a structure positioned above the receiver.

5. The system of claim 1 wherein the receiver attachment portion includes first and second upwardly and outwardly extending arms, each having an attachment element positioned to suspend the receiver attachment member from an overhead structure.

6. The system of claim 5 wherein the first and second arms are integrally formed with the first bushing portion.

7. The system of claim 1 wherein the first and second receiver attachment members are removably coupled to each other via at least one bolt.

8. The system of claim 1 wherein the first and second elements are removably coupled to each other via at least one stud and a corresponding nut.

9. The system of claim 1 wherein the receiver includes a first section welded to a second section at a joint, and wherein the bearing is positioned over the joint.

10. A bearing for a solar concentrator system, comprising:
a receiver attachment member having a first bushing portion and a second bushing portion removably coupled to the first bushing portion, the first bushing portion having an outwardly-facing bearing surface, the receiver attachment member further including a plurality of receiver engagement surfaces positioned to contact an outer surface of a receiver conduit; and
a concentrator attachment member having a first element and a second element removably coupled to the first element, the first and second elements each having an inwardly-facing bearing surface positioned to rotatably engage with the outwardly-facing bearing surface of the first bushing portion, the concentrator attachment member further having first and second attachment elements positioned to couple to a solar concentrator.

11. The system of claim 10 wherein the plurality of receiver engagement surfaces includes at least one first receiver engagement surface carried by the first bushing portion and at least one second receiver engagement surface carried by the second bushing portion.

12. The system of claim 10, further comprising a thermal insulating material positioned adjacent to at least one of the receiver engagement surfaces.

13. The system of claim 10 wherein the receiver attachment portion includes first and second upwardly and outwardly extending arms, each having an attachment element positioned to suspend the receiver attachment member from an overhead structure.

14. The system of claim 3 wherein the first and second arms are integrally formed with the first bushing portion.

15. A method for assembling a solar collector system, the method comprising:
connecting first and second portions of a receiver attachment member to each other around a tubular receiver;
connecting first and second elements of a concentrator attachment member to each other around the receiver attachment member, with an inwardly-facing bearing surface of the concentrator attachment member in contact with an outwardly-facing bearing surface of the receiver attachment member;
suspending the receiver attachment member from an overhead structure; and
suspending a solar concentrator from the concentrator attachment member.

16. The method of claim 15 wherein connecting the first and second portions of the receiver attachment member includes releasably connecting the first and second portions of the receiver attachment member.

17. The method of claim 15 wherein connecting the first and second elements of the concentrator attachment member includes releasably connecting the first and second elements of the concentrator attachment member.

18. The method of claim 15 wherein the receiver includes a first section welded to a second section at a joint, and wherein the method further comprises positioning the first and second portions of the receiver attachment member over the joint.

19. The system of claim 15, further comprising positioning a plurality of spaced-apart receiver engagement surfaces, carried by the receiver attachment member, in contact an outer surface of the.

20. The system of claim 15, further comprising positioning a thermal insulating material adjacent to at least one of the receiver engagement surfaces.
